(19) United States
(12) Patent Application Publication
(10) Pub. No.: US 2007/0229729 A1
(43) Pub. Date: Oct. 4, 2007

(54) Liquid crystal display device

(75) Inventors: Seiichi Nishiyama, Mobara (JP); Hiroyuki Yoshida, Mobara (JP); Akiyoshi Tobe, Mobara (JP)

Correspondence Address: Stanley P. Fisher;Reed Smith LLP, Suite 1400, 3110 Fairview Park Drive, Falls Church, VA, 22042-4503, US

(73) Assignee: Hitachi Displays, Ltd.

(21) Appl. No.: 11/586,659

(22) Filed: Oct. 26, 2006

(30) Foreign Application Priority Data
Oct. 28, 2005 (JP) 2005-313691

(51) Int. Cl. G02F 1/1335

(52) U.S. Cl. 349/62

(57) ABSTRACT

The present invention provides a liquid crystal display device having a backlight device which can realize the high brightness and the high uniformity of in-plane brightness by allowing an optical sheet which is arranged above a light guide plate to effectively make use of light from spot light sources. An optical sheet is arranged between a side-light-type backlight device which includes a light guide plate and spot light sources on one side surface of the light guide plate and a liquid crystal display panel. The optical sheet is constituted of a sheet-like transparent base member and a plurality of convex lenses which are arranged on a backlight-device-side surface of the transparent base member. The convex lenses have a circular bottom surface shape and the centers of the bottom surfaces of the lenses are periodically arranged.

### CROSS-REFERENCE TO RELATED APPLICATION

The disclosure of Japanese Patent Application No. 2005-313691 filed on Oct. 28, 2005 including the specification, drawings and abstract is incorporated herein by reference in its entirety.

### BACKGROUND OF THE INVENTION

1. Field of the Invention

The present invention relates to a liquid crystal display device, and more particularly to a liquid crystal display device in which a side-light-type backlight device is arranged on a back surface of a liquid crystal display panel.

2. Description of the Related Arts

A liquid crystal display device having a backlight device is roughly classified into two types of liquid crystal display devices, that is, a liquid crystal display device having a side-light-type backlight device which includes a light guide plate and a light source such as a CCFL or an LED which is arranged on a side surface of the light guide plate and a liquid crystal display device having a direct-type backlight device which arranges a plurality of CCFL or LED directly below a liquid crystal display panel.

Patent document 1 (U.S.Pat. No. 5126882) discloses the constitution in which a prism sheet forming a large number of prism units is arranged on a light emitting surface side of a light guide plate of a side-light-type backlight device in a state that the prism sheet faces the light guide plate. The prism units of this prism sheet extend in the direction parallel to a linear light source (lamp) arranged on a side surface of the light guide plate and have a triangular cross section.

Patent document 2 (Japanese Patent Laid-Open No. 2004-302329) discloses a direct-type backlight device in which a plurality of LEDs which constitute spot light sources in place of a linear light source such as a CCFL is arranged. Patent document 2 also discloses the constitution in which an optical sheet on which pyramidal lenses are formed is arranged in a state that the prism sheet faces the plurality of LED light sources.

Patent document 3 (Japanese Patent Laid-Open Hei 07-218707) discloses the constitution in which a light diffusion plate is arranged on a light guide plate of a side-light-type backlight device. Patent document 3 also discloses the constitution in which the light diffusion plate has conic projections arranged on a side thereof opposite to the light guide plate, that is, on a side thereof which faces a liquid crystal panel.

### SUMMARY OF THE INVENTION

Patent document 1 discloses the technique on a premise that the light source which is arranged on the side surface of the light guide plate is basically a linear light source such as a CCFL. That is, in the side-light-type backlight device disclosed in patent document 1, light is incident on a light incident surface of the light guide plate in the direction perpendicular to the light incident surface, the light is radiated from the light radiation surface in the direction perpendicular to the light incident surface of the light guide plate, the radiation light is incident on the prism sheet having prism units which extend in the direction parallel to the linear light source, and the light is efficiently radiated from the prism sheet in the direction toward a front side of the liquid crystal display panel. That is, by arranging the prism sheet having a prism shape which effectively utilizes the light incident on the light incident surface of the light guide plate in the direction perpendicular to the light incident surface, light is effectively used.

However, when the spot light sources such as LEDs are arranged on one side surface of the light guide plate of the side-light-type backlight device, an incident angle of light differs depending on a position on a light incident surface of the light guide plate. Particularly, at an intermediate position between one spot light and another spot light, light is incident in the oblique direction with respect to the direction perpendicular to the light incident surface. Accordingly, the light radiated from the light radiation surface of the light guide plate in a region close to the light incident surface of the light guide plate within an intermediate region between one spot light source and another spot light source, contain a small amount of components thereof perpendicular to the light incident surface of the light guide plate. It is not possible to effectively radiate light in the front direction of the liquid crystal panel from the prism sheet, even when the prism sheet having the prism units which extend in the direction parallel to the light incident surface of the light guide plate is used. As a result, when viewed from the front direction of the liquid crystal display device, the brightness of the radiation surface of the light guide plate in the region close to the light incident surface of the light guide plate within the intermediate region between one spot light source and another light source is lowered compared to the brightness in other regions. That is, the uniformity of in-plane brightness on a display screen of the liquid crystal display panel is deteriorated.

Patent document 2 discloses only the optical sheet in the direct-type backlight device, and a case in which the optical sheet is used in a side-light-type backlight device is not taken into consideration.

Patent document 3 discloses the side-light-type backlight device. However, the light diffusion plate arranged on the light guide plate is a light diffusion plate in which conic projections are arranged on the side thereof opposite to the light guide plate, that is, on the side thereof which faces a liquid crystal panel and hence, the optical sheet is not configured to effectively direct light incident from the light guide plate with a predetermined angle in the perpendicular direction.

Accordingly, in these conventional techniques, although the liquid crystal display device having the backlight device in which the lenses of the optical sheet are used in a state that the lenses face the light guide body can obtain high brightness with small number of parts, since the uniformity of in-plane brightness is at a low level, the number of products to which these techniques are applicable is limited.

Accordingly, it is an object of the invention to provide a liquid crystal display device which uses spot light sources in a side-light-type backlight device, wherein an optical sheet which is arranged above a light guide plate is configured to effectively make use of light from the spot light sources thus realizing high brightness and high uniformity of in-plane brightness whereby it is possible to achieve the low power consumption.

According to one aspect of the invention, in a liquid crystal display device having a liquid crystal display panel and a backlight device, the backlight device is a side-light-type backlight device which includes a light guide plate and spot light sources arranged on one side surface of the light guide plate, an optical sheet is arranged between the backlight device and the liquid crystal display panel, the optical sheet is formed of a sheet-like transparent base member and a plurality of convex lenses which is arranged on a surface on a backlight-device-side of the transparent base member, and the convex lenses have a circle bottom surface shape, and the centers of the bottom surfaces of the lenses are periodically arranged.

Further, in the optical sheet, an interval between the centers of the bottom surfaces of the convex lenses which are arranged close to each other differs between the direction parallel to one side surface of the light guide plate and the direction perpendicular to one side surface of the light guide plate.

Further, the interval between the centers of the bottom surfaces of the convex lenses of the optical sheet which are arranged close to each other is set such that the distance between the centers of the bottom surfaces of the convex lenses in the direction parallel to one side surface of the light guide plate (that is, in the direction parallel to the side surface on which the spot light sources are arranged) is smaller than the distance between the centers of the bottom surfaces of the convex lenses in the direction perpendicular to one side surface of the light guide plate (that is, in the direction perpendicular to one side surface of light guide plate on which the spot light sources are arranged).

Further, in the liquid crystal display device, it may be also effective to arrange the convex lenses in a state that portions of the bottom surfaces of the respective convex lenses are overlapped to each other. Here, the bottom surface implies the vicinity of the bottom surface.

Here, it is needless to say that one side surface of the light guide plate of the invention implies that the spot light sources are arranged on at least one side surface of the light guide plate and it may be possible to arrange another light sources on a side surface of the light guide plate opposite to one side surface. Here, when the spot light sources are arranged on only one side surface of the light guide plate, it is possible to reduce the number of light sources thus reducing a manufacturing cost.

According to another aspect of the invention, in a liquid crystal display device having a liquid crystal display panel and a backlight device, the backlight device is a side-light-type backlight device which includes a light guide plate and spot light sources arranged on one side surface of the light guide plate, an optical sheet is arranged between the backlight device and the liquid crystal display panel, the optical sheet is formed of a sheet-like transparent base member and a plurality of convex lenses which is arranged on a surface on a backlight-device-side of the transparent base member, and the convex lenses have a circle bottom surface shape and the centers of the bottom surfaces of the lenses are periodically arranged.

Further, in the optical sheet, an interval between the centers of the bottom surfaces of the convex lenses which are arranged close to each other differs between the direction parallel to one side surface of the light guide plate and the direction perpendicular to one side surface of the light guide plate.

Also in the liquid crystal display device of this aspect of the invention, it may be effective to arrange the convex lenses in a state that portions of the bottom surfaces of the respective convex lenses are overlapped to each other.

According to the invention, in the liquid crystal display device having the side-light-type backlight device which uses the spot light sources, high brightness and high uniformity of in-plane brightness can be realized thus providing the liquid crystal display device having the backlight device which can realize the low power consumption.

Further, according to the invention, by enhancing the number of products to which the invention is applicable, it is possible to provide the liquid crystal display device which can obtain a material-cost reducing effect as the whole of backlight device.

### BRIEF DESCRIPTION OF THE DRAWINGS

FIG. 1 is a side view showing the constitution of an embodiment 1;

FIG. 2 is another side view showing the constitution of FIG. 1 of the embodiment 1 as viewed from a side on which light sources are arranged;

FIG. 3 is a view showing the angle distribution of radiation lights from a light radiation surface of a light guide plate in the direction perpendicular to the light incident surface in the side view showing the constitution of the embodiment 1;

FIG. 4 is a view showing a state of the radiation light from the light radiation surface in the vicinity of the light incident surface of the light guide plate;

FIG. 5A to FIG. 5C are views showing an optical sheet of the embodiment 1, wherein FIG. 5A is a plan view, FIG. 5B is a side vide and FIG. 5C is another side view;

FIG. 6 is a stereoscopic perspective view of the optical sheet of the embodiment 1;

FIG. 7A to FIG. 7C are views showing an optical sheet of the embodiment 2, wherein FIG. 7A is a plan view, FIG. 7B is a side vide and FIG. 7C is another side view;

FIG. 8 is a side view showing the constitution of an embodiment 3;

FIG. 9 is a side view showing the constitution of the embodiment 3 as viewed from a side on which light sources are arranged;

FIG. 10A to FIG. 10C are views showing an optical sheet of the embodiment 3, wherein FIG. 10A is a plan view, FIG. 10B is a side vide and FIG. 10C is another side view;

FIG. 11A and FIG. 11B are perspective views of the optical sheet of the embodiment 3;

FIG. 12 is a stereoscopic perspective view of the optical sheet of the embodiment 3;

FIG. 13 is a side view showing the constitution of a comparison example 1;

FIG. 14 is a side view showing the constitution of the comparison example 1 as viewed from a side on which light sources are arranged;

FIG. 15 is a view showing the angle distribution of radiation lights from a light radiation surface of the light guide plate in the direction perpendicular to the light incident surface in the side view showing the constitution of the comparison example 1;

FIG. 16 is a view showing the radiation light from the light radiation surface of the light guide plate in the comparison example 1;

FIG. 17 is a view showing the in-plane brightness distribution in the front direction on the light radiation surface of an optical sheet in the comparison example 1;

FIG. 18 is a side view showing the constitution of a comparison example 2;

FIG. 19 is a side view showing the constitution of the comparison example 2 as viewed from a side on which light sources are arranged;

FIG. 20 is a view showing the in-plane brightness distribution in the front direction of the radiation surface of an optical sheet in the constitution of the comparison example 2;

FIG. 21A to FIG. 21C are views showing an optical sheet of the embodiment 4, wherein FIG. 21A is a plan view, FIG. 21B is a side view, and FIG. 21C is another side view;

FIG. 22A and FIG. 22B are perspective views of the optical sheet of the embodiment 4;

FIG. 23 is a cross-sectional view of an optical sheet of an embodiment 5;

FIG. 24 is a cross-sectional view of an optical sheet of an embodiment 6;

FIG. 25 is a cross-sectional view of an optical sheet of an embodiment 7; and

FIG. 26 is a cross-sectional view of an optical sheet of an embodiment 8.

### DETAILED DESCRIPTION OF THE INVENTION

Hereinafter, embodiments of the invention are explained in detail in conjunction with drawings.

### Embodiment 1

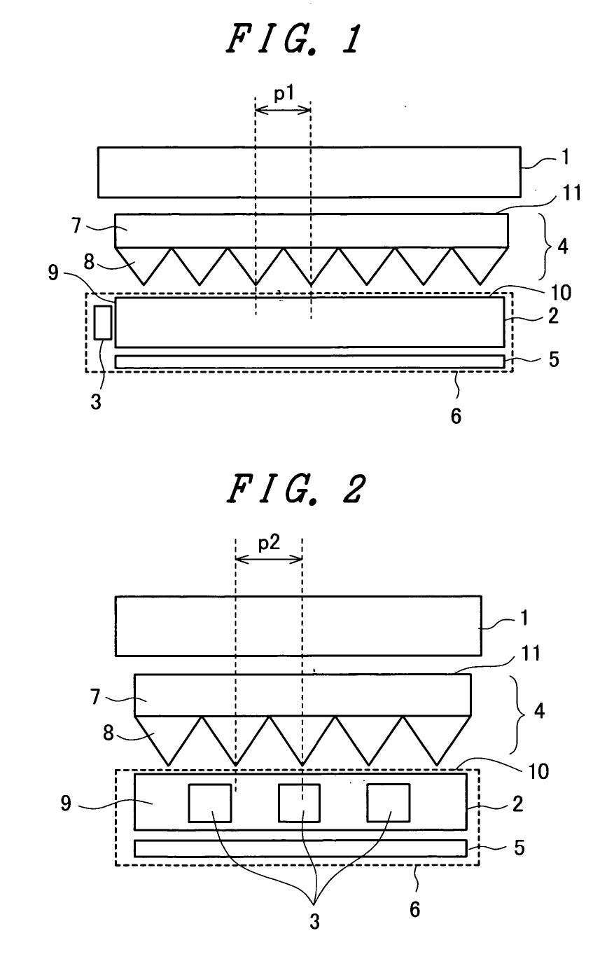

FIG. 1 is a side view of the constitution of a liquid crystal display device according to an embodiment of the invention.

In a liquid crystal display device shown in FIG. 1, a liquid crystal display panel 1, a light guide plate 2 which is arranged on a back surface of the liquid crystal display panel 1, spot light sources 3 which are arranged on one side surface 9 of the light guide plate 2, and an optical sheet 4 which is arranged between the liquid crystal display panel 1 and the light guide plate 2 and which allows the incidence of a radiation light from the light guide plate 2 to the optical sheet 4 and the subsequent radiation of the radiation light from the optical sheet 4 in the predetermined direction are arranged. Here, a reflection plate 5 is also arranged on the back surface of the light guide plate 2. Here, although the light guide plate 2, the spot light sources 3, and the reflective plate 5 may be collectively referred to as a backlight device 6, it is needless to say that the structure which further includes the optical sheet 4 may be also referred to as the backlight device 6.

The optical sheet 4 is constituted by periodically arranging convex lenses 8 on a surface of the transparent base member 7. A bottom surface shape of the convex lenses is a circle. With respect to a case shown in FIG. 1, the convex lenses have a conic shape. These lenses are arranged in a state that the lenses face the light guide plate 2.

FIG. 2 is another side view of the constitution shown in FIG. 1 as viewed from a side on which the spot light sources 3 are arranged.

As can be clearly understood from FIG. 1 and FIG. 2, with. respect to the conical lenses 8 which are formed on the transparent base member 7, an interval (p2) between the centers of the bottom surfaces of the lenses 8 in the direction parallel to the light incident surface (the above-mentioned one side surface 9) of the light guide plate 2 is set equal to an interval (p1) between the centers of the bottom surfaces of the lenses in the direction perpendicular to the light incident surface of the light guide plate 2.

FIG. 1 and FIG. 2 show an embodiment in which, assuming a radius of the bottom surface of the conical lenses 8 as R, the relationship p2=p1=2R is established.

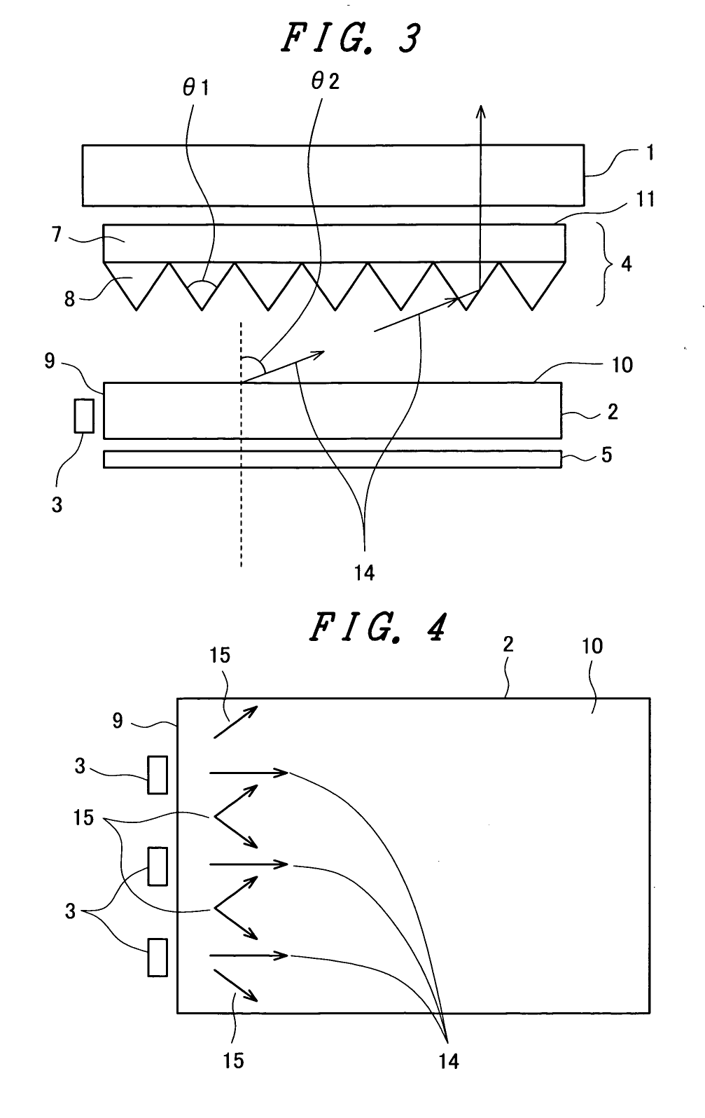

FIG. 3 is a view explaining the angle distribution of the radiation light 14 from the light radiation surface 10 of the light guide plate 2 in the direction perpendicular to the light incident surface 9. A groove pattern or the like is preliminarily formed on a surface of a light-reflection-plate 5 side of the light guide plate 2 such that an angle θ2 which is made by the radiation light 14 and the normal direction of the light radiation surface 10 of the light guide plate 2 assumes a value which falls within a range from approximately 60 degree to 80 degree.

An apex angle θ1 of the conical lenses 8 on the optical sheet 4 is set to 50 degrees or more and 100 degrees or less. That is, it is most preferable to set the apex angle of the conic shape to 68 degrees (±1 degree), it is preferable to set the apex angle to 68 degrees (±2 degree), it is allowable to some extent to set the apex angle to 68 degrees (±5 degree), and an allowable range of the apex angle is 50 degrees or more and 100 degrees or less.

The light 14 which is radiated at an angle of approximately 60 degrees to 80 degrees with respect to the normal direction of the light radiation surface 10 of the light guide plate 2 is incident and is refracted on one surface of the conical lens 8 on the optical sheet 4, is reflected on another surface of the lens 8 and, thereafter, is radiated from the light radiation surface 11 of the optical sheet 4 at an angle close to the normal direction of the light radiation surface 10 of the light guide plate 2.

FIG. 4 is a view showing a state of the radiation lights from the light radiation surface 10 of the light guide plate 2 in the vicinity of the light incident surface 9. In the vicinity of the spot light sources 3, the radiation lights 14 are radiated in the direction perpendicular to the light incident surface 9. In the vicinity of the intermediate portion between one spot light source and another spot light source, the radiation light 15 having an angle with respect to the direction perpendicular to the light incident surface 9 are radiated.

In the embodiment shown in FIG. 1 and FIG. 2, since the lenses 8 of the optical sheet 4 has a conic shape and hence, it is possible to make both of the radiation light 14 and the radiation light 15 of FIG. 4 efficiently radiated in the direction toward the front side of the liquid crystal display panel 1. Due to such a constitution, it is possible to obtain the high uniformity in in-plain brightness.

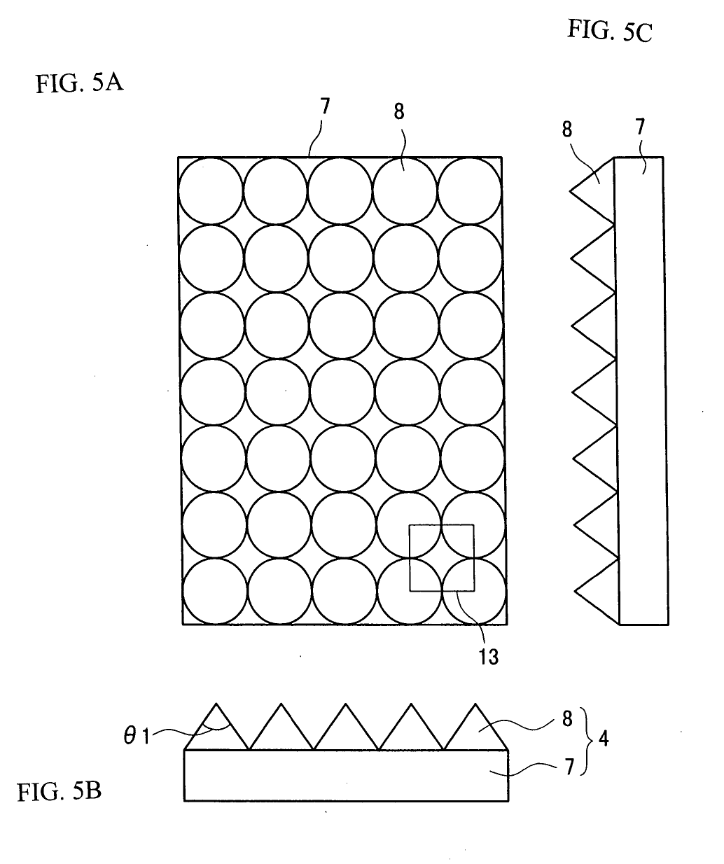

FIG. 5A to FIG. 5C are views showing the optical sheet 4, wherein FIG. 5A is a plan view, FIG. 5B is a side view as viewed from the same direction as FIG. 1, and FIG. 5C is another side view as viewed from the same direction as FIG. 2.

Assuming a radius of the bottom surface of the conical lens 8 as R, an interval between the centers of the bottom surfaces of the conical lenses which are arranged close to each other is 2R and, at the same time, a shape 13 which connects the centers of the bottom surfaces of the conical lenses which are arranged close to each other forms a square.

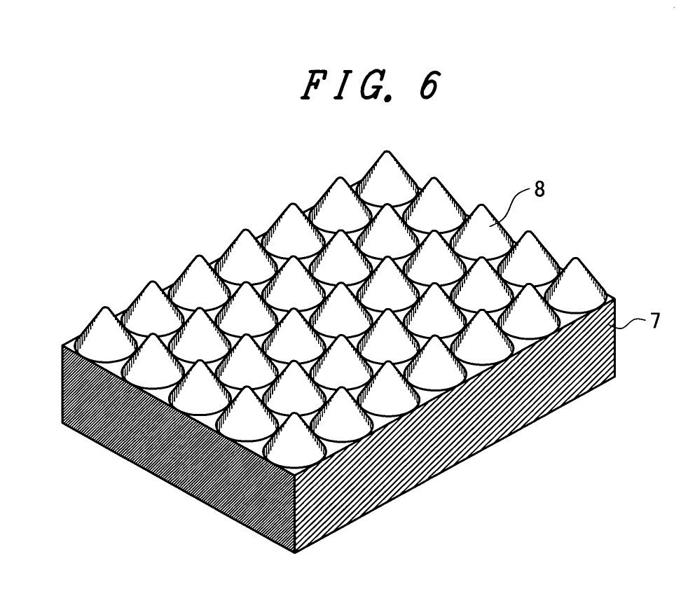

FIG. 6 is a stereoscopic perspective view of the optical sheet 4.

The optical sheet 4 is, when the optical sheet 4 is used in the liquid crystal display device, arranged such that the lenses 8 face the light guide plate 2, wherein a short-side of the transparent base member 7 shown in FIG. 6 constitutes the light incident surface 9 side of the light guide plate 2, and spot light sources 3 are arranged at positions where the spot light sources 3 face the light incident surface 9.

### Embodiment 2

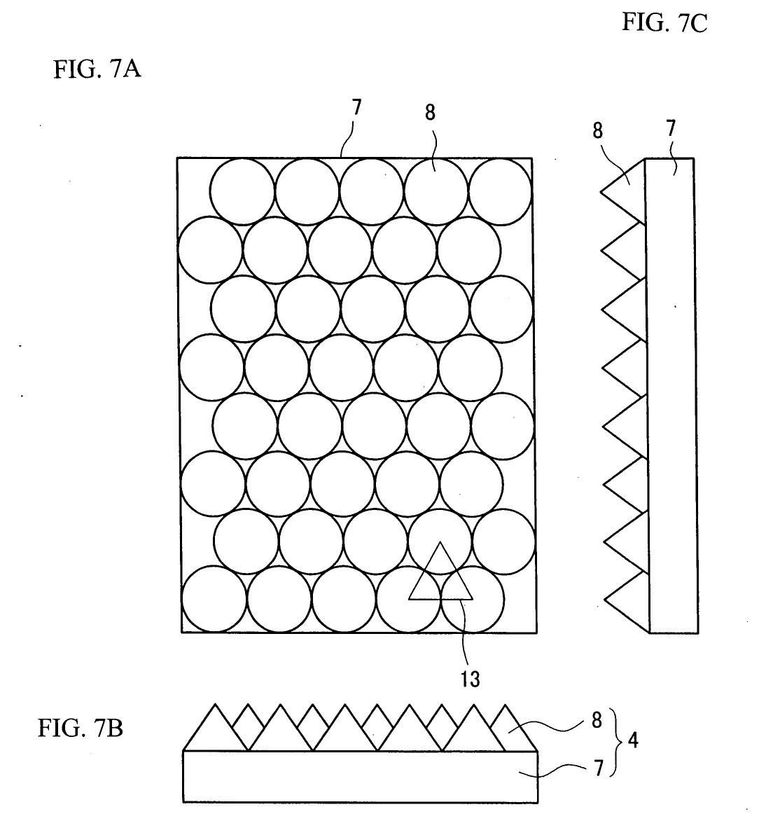

FIG. 7A to FIG. 7C are explanatory views of an embodiment 2 of the invention, wherein FIG. 7A is a plan view, FIG. 7B is a side view, and FIG. 7C is another side view. FIG. 7A to FIG. 7C show a modification of the optical sheet 4.

In using the optical sheet 4 in the liquid crystal display device, the optical sheet 4 is arranged such that the lenses 8 face the light guide plate 2, wherein the short-side of the transparent base member 7 shown in FIG. 5A to FIG. 5C constitutes the light-incident-surface-9-side of the light guide plate 2, and spot light sources are arranged at positions where the spot light sources face the light incident surface 9. Assuming a radius of the bottom surface of the conical lens 8 as R, an interval between the centers of the bottom surfaces of the conical lenses-which are arranged close to each other is 2R and, at the same time, a shape 13 which connects the centers of the bottom surfaces of the conical lenses which are arranged close to each other forms an equilateral triangle. To compare the optical sheet 4 of this embodiment 2 with the optical sheet 4 of the embodiment 1 shown in FIG. 5A to FIG. 5C, although the lenses of this embodiment have the same conical shape as the lenses of the embodiment 1, it is possible to increase the density of cones per unit area and hence, it is possible to acquire the higher front-surface brightness.

### Embodiment 3

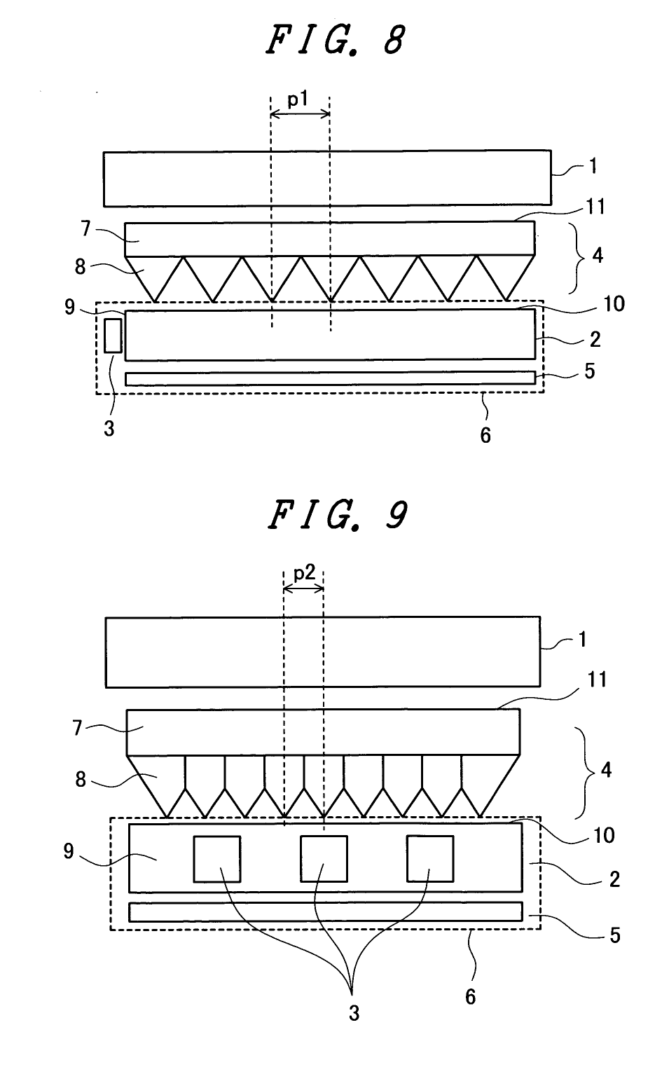

FIG. 8 and FIG. 9 are side views of the constitution of a liquid crystal display device according to an embodiment 3 of the invention.

FIG. 8 is a side view as viewed from a side surface perpendicular to a light incident surface 9, and FIG. 9 is another side view as viewed from a side on which light sources are arranged. The constitution which makes this embodiment different from the constitution of the embodiment 1 lies in the constitution of the optical sheet 4 which is arranged above the light guide plate 2.

The optical sheet 4 of the embodiment 3 is configured such that conical lenses 8 are periodically arranged on the surface of a transparent base member 7. Further, the lenses 8 are arranged to face a light guide plate 2.

As can be clearly understood from FIG. 8 and FIG. 9, with respect to the conical lenses 8 which are formed on the transparent base member 7, an interval (p2) between the centers of the bottom surfaces of the lenses 8 in the direction parallel to the light incident surface (the above-mentioned one side surface 9) of the light guide plate 2 made different from an interval (p1) between the centers of the bottom surfaces of the lenses in the direction perpendicular to the light incident surface of the light guide plate 2. That is, FIG. 8 and FIG. 9 show an embodiment in which assuming a radius of the bottom surface of the conical lenses 8 as R, the relationship p2=R, p1=2R is established.

Since the lenses 8 of the optical sheet 4 have a conical shape, both of the radiation light 14 formed of perpendicular components and the radiation light 15 formed of oblique components from the radiation surface 10 of the light guide plate 2 in the vicinity of the light incident surface 9 explained in conjunction with FIG. 4 can be efficiently radiated in the direction toward the front surface of the liquid crystal display panel 1. Accordingly, the liquid crystal display device can obtain the high uniformity of in-plane brightness.

Further, the optical sheet 4 shown in FIG. 8 and FIG. 9 can increase an area of the lens 8 in a side view as viewed from the side on which the light sources 3 are arranged larger than an area of the lens 8 in the side view as viewed from the side on which the light sources 3 of the embodiment 1 shown in FIG. 2 are arranged. Accordingly, the radiation light 14 formed of perpendicular components and the radiation light 15 formed of oblique components from the light radiation surface 10 of the light guide plate 2 can be efficiently radiated in the direction toward the front surface of the liquid crystal display panel 1 thus realizing the acquisition of the high front surface brightness.

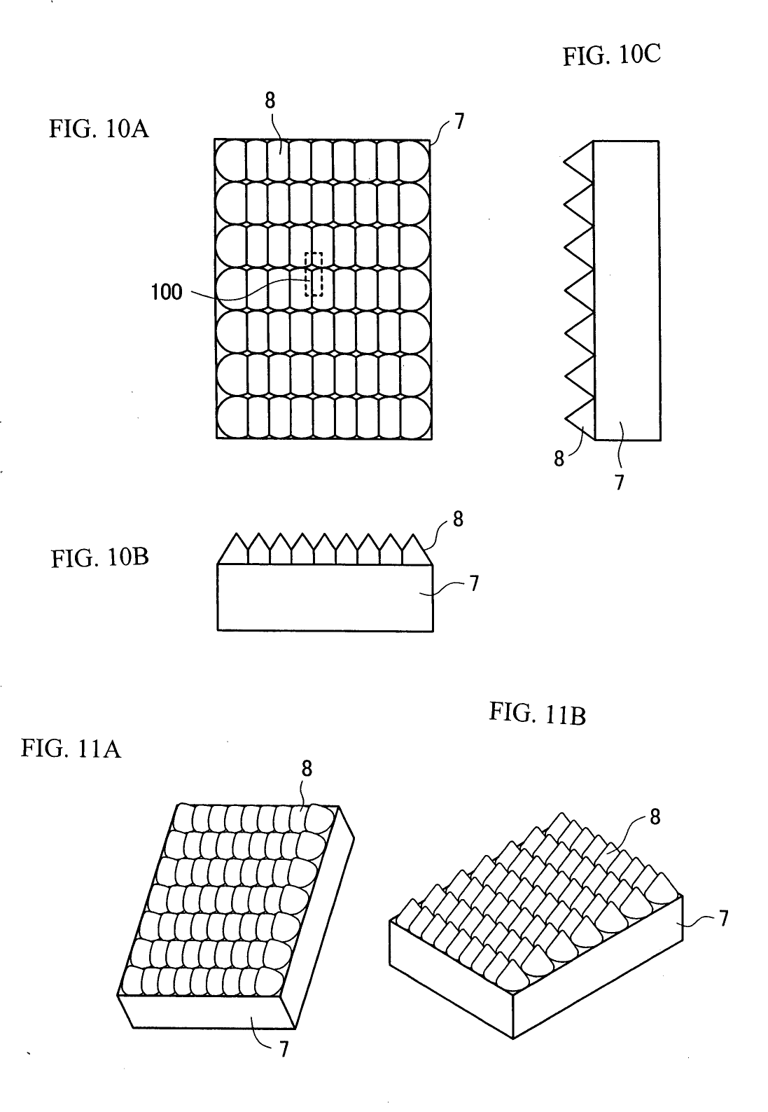

FIG. 10A to FIG. 10C are views showing an optical sheet 4 of this embodiment, wherein FIG. 10A is a plan view, FIG. 10B is a side vide, and FIG. 10C is another side view.

FIG. 10B is a side view as viewed from the same direction in FIG. 8, and FIG. 10C is a side view as viewed from the same direction in FIG. 9. As indicated by numeral 100 in FIG. 10, a shape which connects the centers of the bottom surfaces of the conical lenses 8 which are arranged close to each other is a rectangular shape.

FIG. 11A and FIG. 11B are perspective views of the optical sheet 4 of the embodiment 3, wherein FIG. 11A and FIG. 11B are perspective views as viewed from the different directions.

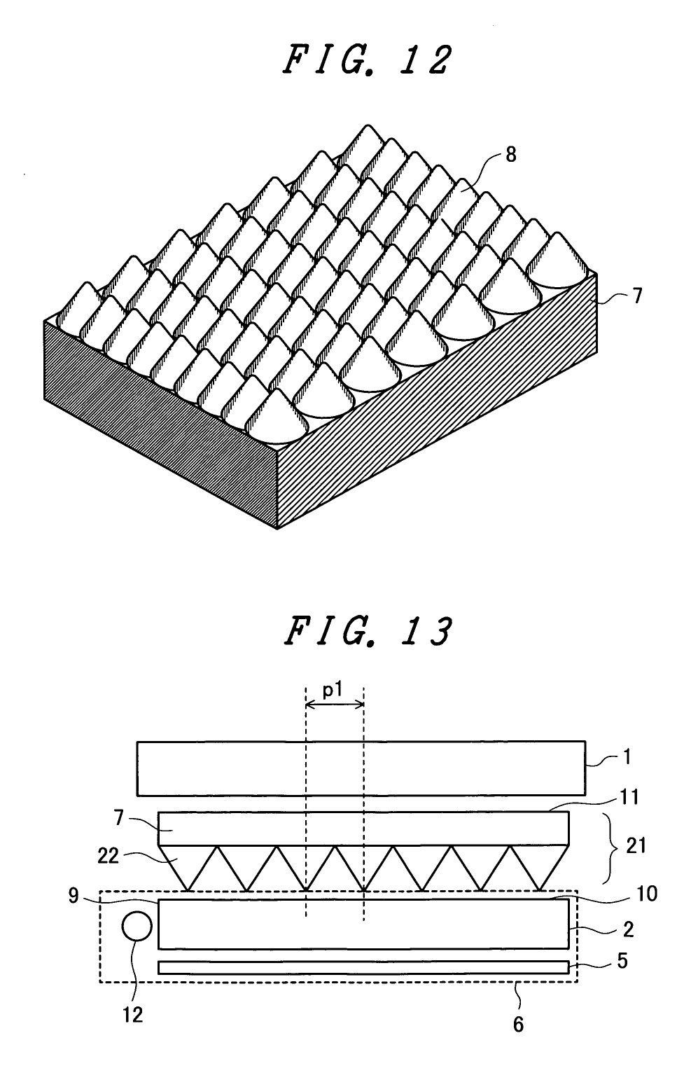

FIG. 12 is a stereoscopic perspective view of the optical sheet 4 of the embodiment 3.

In using the optical sheet 4 in the liquid crystal display device, the lenses 8 are arranged to face a light guide plate 2, wherein a short-side of a transparent base member 7 in FIG. 10 constitutes a light-incident-surface-9-side of the light guide plate 2, and spot light sources are arranged at positions which face the light incident surface 9.

### Comparison example 1

FIG. 13 shows an example in which a light source is formed of a linear light source such as a CCFL and an optical sheet 21 which is constituted of a transparent base member 7 and lenses 22 having a triangular cross section which are arranged periodically in the direction parallel to the linear light source while facing a side of the transparent base member 7 on which a light guide plate 2 is arranged.

FIG. 13 shows a liquid crystal display device which includes a liquid crystal display panel 1, a light guide plate 2 which is arranged on a back surface of the liquid crystal display panel 1, a linear light source 12 which is arranged on one side surface 9 of the light guide plate 2, and an optical sheet 21 which is arranged between the liquid crystal display panel 1 and the light guide plate 2 and which allows the incidence of a radiation light from the light guide plate 2 to the optical sheet 21 and the subsequent radiation of the radiation light from the optical sheet 21 in the predetermined direction are arranged. Here, a reflection plate 5 is also arranged on the back surface of the light guide plate 2.

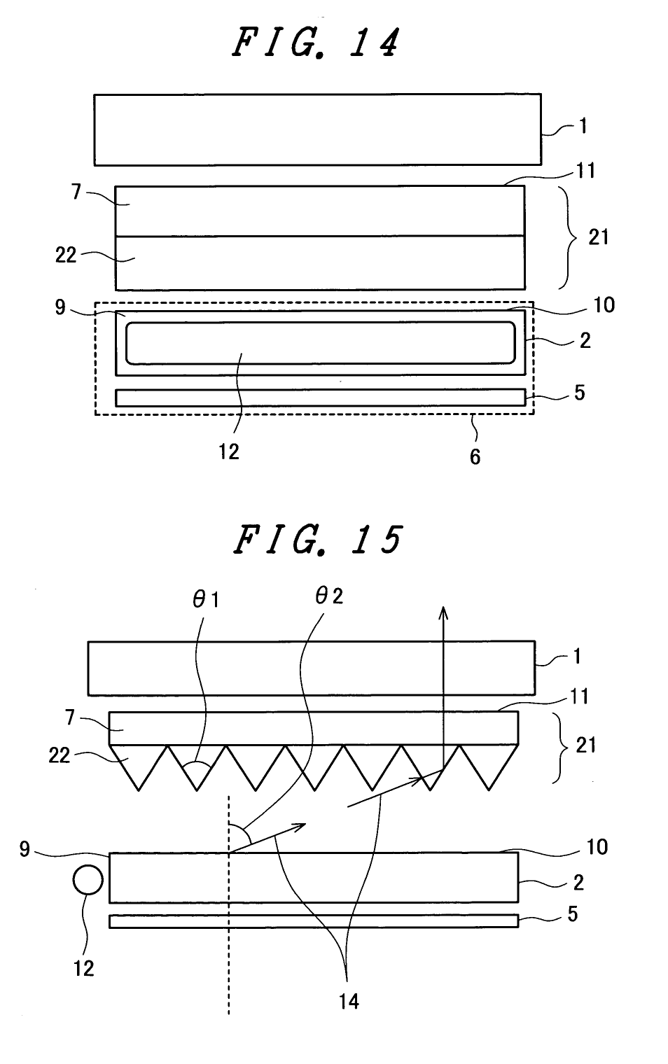

FIG. 14 is another side view of FIG. 13 as viewed from a side on which linear light sources 12 are arranged.

In this comparison example, as shown in FIG. 15, light is incident on the light incident surface 9 of the light guide plate 2 in the direction perpendicular to the light incident surface 9 of the light guide plate 2 and light is radiated from a radiation surface 10 of the light guide plate 2 in the direction perpendicular to the light incident surface 9 of the light guide plate 2. The radiation light 14 is allowed to be incident on the optical sheet 21 including lenses 22 having a triangular cross section which extend in the direction parallel to the linear light source 12, and the light is efficiently radiated in the direction toward the front surface of the liquid crystal display panel 1 from an radiation surface 11 of the optical sheet 21. That is, by arranging the lens-shaped optical sheet which effectively make use of the light incident on the direction perpendicular to the light incident surface 9 of the light guide plate 2, it is possible to effectively make use of light.

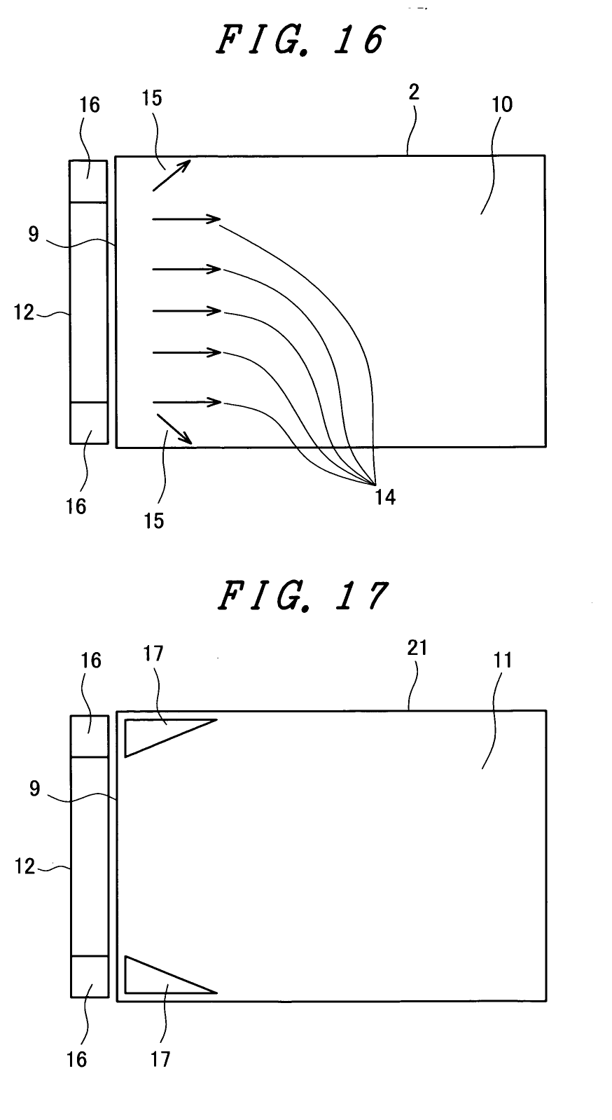

However, as shown in FIG. 16, non-light emitting regions 16 are formed at both end portions of the linear light source 12, wherein with respect to the light incident surface 9 of the light guide plate 2 in the vicinity of the non-light emitting regions 16, light cannot enter the light guide plate 2 in the direction perpendicular to the light incident surface 9. Accordingly, from the light radiation surface 10 of the light guide plate 2 in the vicinity of the non-light emitting regions 16, the radiation light 15 in the direction oblique to the direction perpendicular to the light incident surface 9 is radiated.

The radiation light 15 in the oblique direction cannot be incident perpendicularly to the convex lenses 22 which extend in the direction parallel to the linear light source 12 and hence, it is difficult to efficiently radiate light in the direction toward the front surface of the liquid crystal display panel 1 from the radiation surface 11 of the optical sheet 21.

Accordingly, as shown in FIG. 17, with respect to the in-plane brightness distribution in the direction toward the front face on the radiation surface 11 of the optical sheet 21, there arises a drawback that in the vicinity of the non-light emitting regions 16 at both end portions of the linear light source 12, regions 17 which exhibit low brightness are generated.

### Comparison example 2

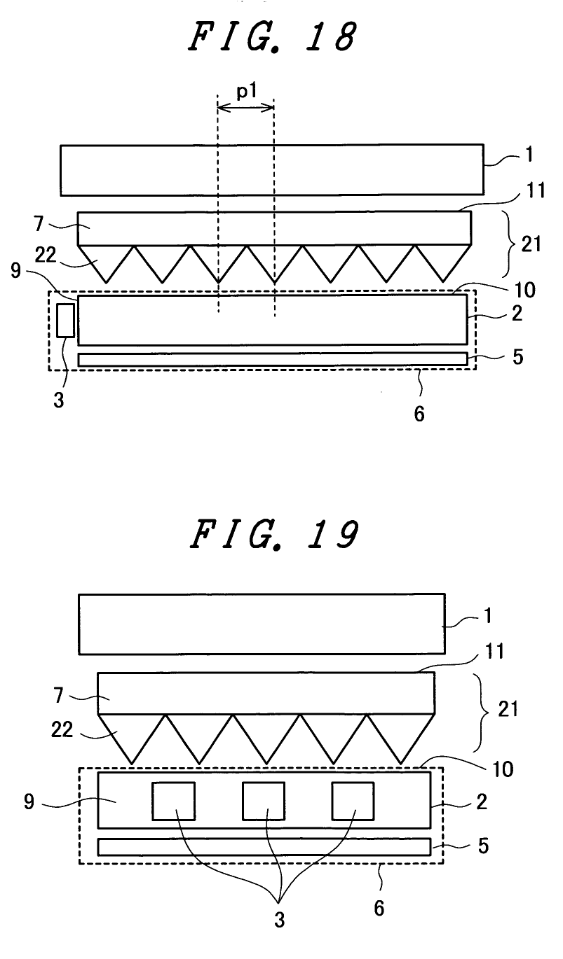

FIG. 18 is a side view of the constitution of another comparison example.

FIG. 18 shows a liquid crystal display device which includes a liquid crystal display panel 1, a light guide plate 2 which is arranged on a back surface of the liquid crystal display panel 1, spot light sources 3 which are arranged on one side surface 9 of the light guide plate 2, and an optical sheet 21 which is arranged between the liquid crystal display panel 1 and the light guide plate 2 and which allows the incidence of a radiation light from the light guide plate 2 to the optical sheet 21 and the subsequent radiation of the radiation light from the optical sheet 21 in the predetermined direction are arranged. Here, a reflection plate 5 is also arranged on the back surface of the light guide plate 2.

The optical sheet 21 is configured to periodically arrange lenses 22 having a triangular cross section on the surface of a transparent base member 7. The lenses 22 having a triangular cross section extend in the direction parallel to one side surface (light incident surface 9) of the light guide plate 2. The lenses 22 having a triangular cross section are also arranged to face the light guide plate 2.

FIG. 19 is another side view similar to the side view shown in FIG. 18 showing the constitution of another comparison example as viewed from the side on which the light sources 3 are arranged.

To explain again using FIG. 4, with respect to the radiation light from the light radiation surface 10 of the light guide plate 2 in the vicinity of the light incident surface 9, the radiation light 14 is radiated in the direction perpendicular to the light incident surface 9 in the vicinity of the light sources 3, the radiation light 15 having an angle with respect to the direction perpendicular to the light incident surface 9 is radiated in the vicinity of the intermediate portion between one spot light source and another spot light source. The radiation light 15 in the oblique direction cannot be incident perpendicularly to the convex lenses 22 which extend in the direction parallel to the light incident surface 9 and hence, it is difficult to efficiently radiate light in the direction toward the front surface of the liquid crystal display panel 1 from the light radiation surface 11 of the optical sheet 21.

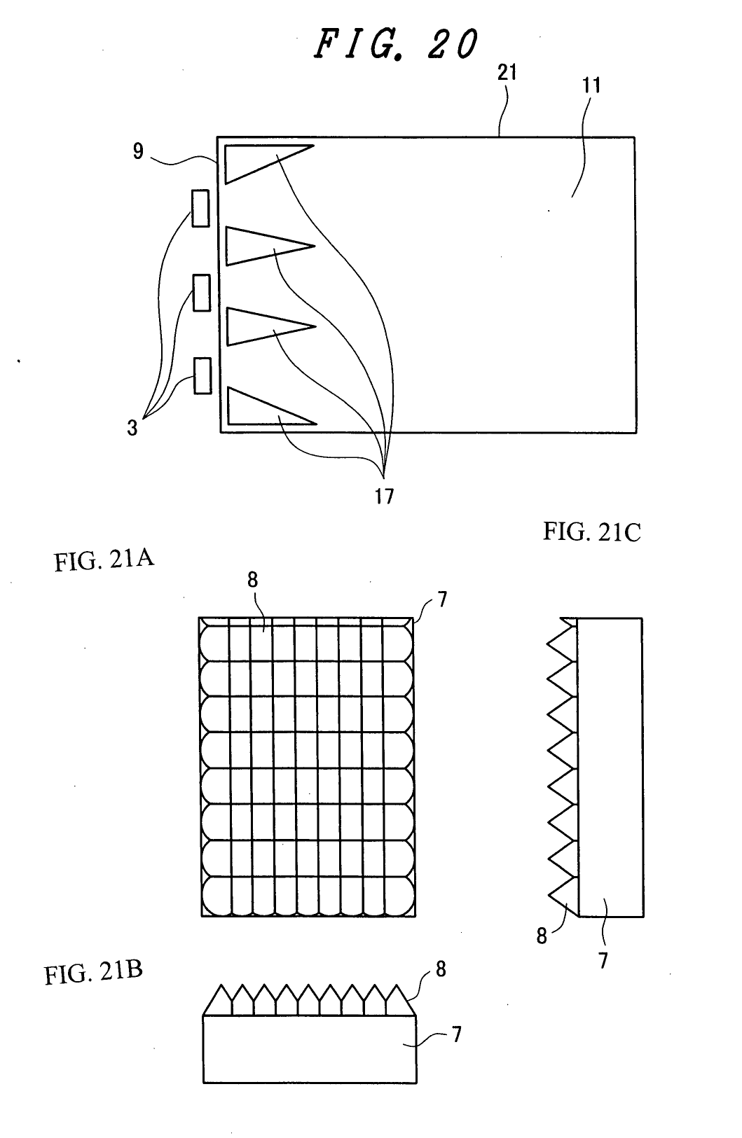

Accordingly, as shown in FIG. 20, with respect to the in-plane brightness distribution in the direction toward the front surface on the light radiation surface 11 of the optical sheet 21, there arises a drawback that in the vicinity of the intermediate portion between one spot light source 3 and another spot light source 3, the region 17 which exhibits low brightness is generated.

### Embodiment 4

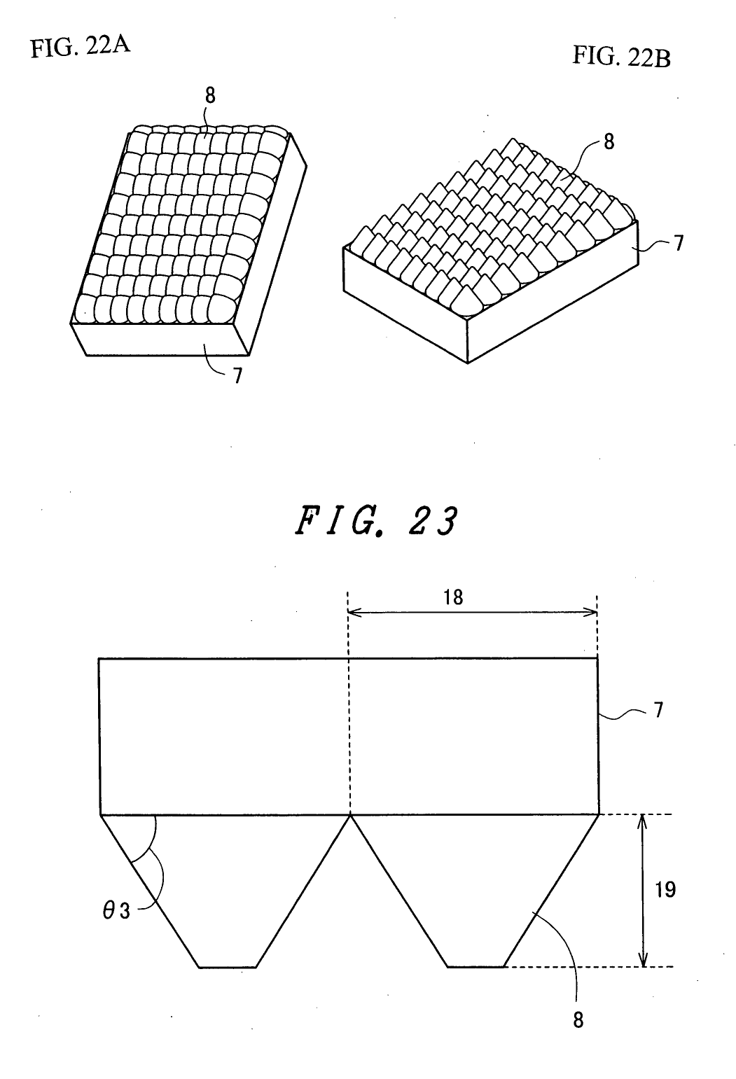

An embodiment 4 of the invention is explained in conjunction with FIG. 21A to FIG. 22B.

The embodiment 4 shows a modification of the optical sheet, wherein FIG. 21A, FIG. 21B and FIG. 21C respectively show a plan view, one side view and another side view of the optical sheet 4, while FIG. 22A and FIG. 22B are perspective views of the optical sheet 4. Here, the constitutions of the embodiment 4 other than the optical sheet 4 are substantially equal to the corresponding constitutions of the embodiment 1.

FIG. 21 shows an example in which, assuming a radius of the bottom surface of the cone as R, the interval between the centers of the bottom surface of the lenses in the direction parallel to the light incident surface 9 of the light guide plate 2 as p2, and the interval between the centers of the bottom surface of the lenses in the direction perpendicular to the light incident surface 9 of the light guide plate 2 as p1, the relationship p2=R, p1=1.5R is established.

By establishing such a relationship, compared to the constitution shown in FIG. 10 which is explained in conjunction with the embodiment 3, it is possible to increase the total area of the lenses of the conical lenses and hence, it is possible to increase the brightness in the direction toward the front surface of the backlight device.

### Embodiment 5

FIG. 23 shows an embodiment 5 of the invention.

The embodiment 5 is directed to a modification of the optical sheet 4, and FIG. 23 is a cross-sectional view of the optical sheet 4. Here, the constitutions other than the constitutional features of the invention which are explained in the embodiment 5 are substantially equal to the constitutions for forming the liquid crystal display device which are explained in the embodiments 1 to 4.

As shown in FIG. 23, the optical sheet 4 of the embodiment 5 has portions of conical lenses 8 in the vicinity of respective apexes thereof formed into a flat surface. This is because that the productivity of the optical sheet 4 can be enhanced by having the portions of conical lenses 8 in the vicinity of respective apexes thereof formed into a flat surface.

As an example of materials of the optical sheet 4, the transparent base member may be made of PET (polyethylene terephthalate) and the lenses may be made of an ultraviolet curing type acrylic resin.

As an example of a manufacturing method of the optical sheet, first of all, an ultraviolet curing type acrylic resin is made to flow between a mold on which conical shapes are arranged and a PET film, ultraviolet rays are radiated in a state that mold and the PET film are hermetically brought into contact with each other thus hardening the resin. Thereafter, the PET film is peeled off from the mold thus completing the optical sheet. With respect to the lenses of the invention, the bottom surfaces of the lenses have a circular shape and are periodically arranged in the longitudinal direction as well as in the lateral direction and hence, compared to the conventional lenses which extend in the direction parallel to the light incident surface of the light guide plate, it is difficult to peel off the PET film from the mold. By forming the vicinity of the apexes of the conical lenses 8 into a flat surface, an angle of the vicinity of the apex of the lens becomes large and a height of the lens becomes low and hence, it is possible to improve the peeling property for peeling off the PET film from the mold after curing the ultraviolet curing type acrylic resin.

### Embodiment 6

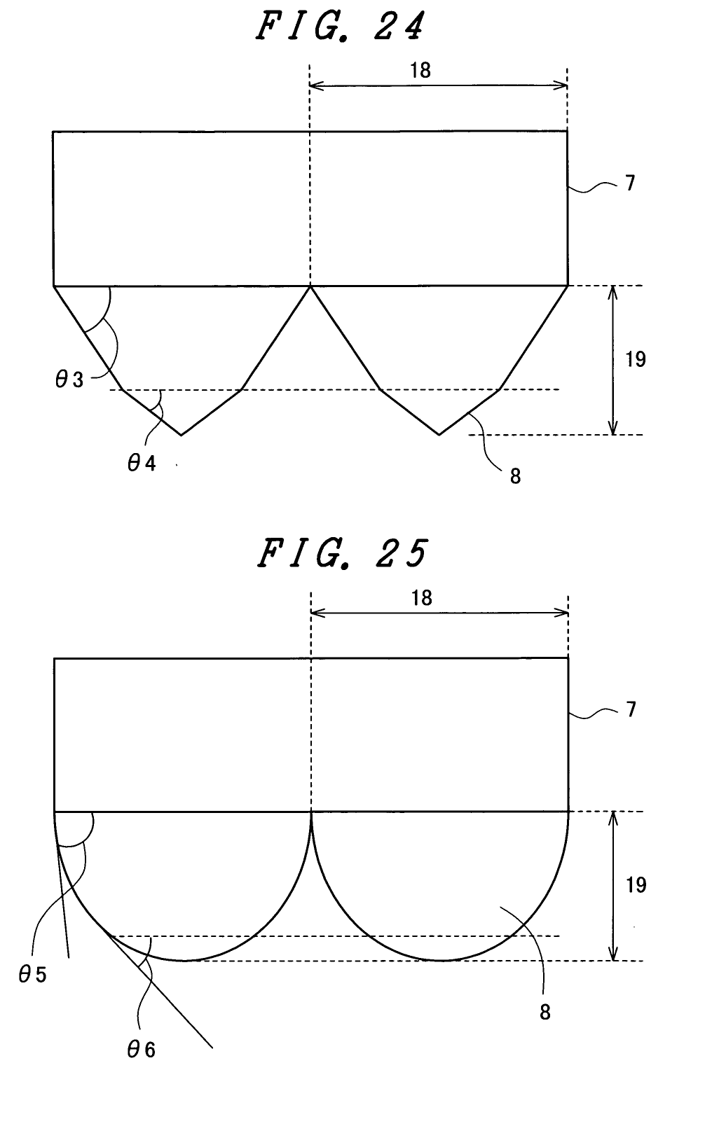

FIG. 24 shows an embodiment 6 of the invention.

The embodiment 6 is directed to a modification of the optical sheet 4 in the same manner as the embodiment 5 and FIG. 24 is a cross-sectional view of the optical sheet 4. Here, the constitutions other than the constitutional features of the invention which are explained in the embodiment 6 are substantially equal to the constitutions for forming the liquid crystal display device which are explained in the embodiments 1 to 4.

As shown in FIG. 24, with respect to the optical sheet 4 of the embodiment 6, a cross-sectional shape of a convex lens including an apex is configured such that an oblique surface of the lens is constituted of at least two straight lines, and an angle θ4 made by the oblique surface close to the apex. of the lens and a bottom surface of the lens is set smaller than an angle θ3 made by the oblique surface close to the bottom surface of the lens and the bottom surface of the lens.

By forming the lens into such a shape, it is possible to enhance the peeling property for peeling off the transparent base member from the mold in the same manner as explained in conjunction with the embodiment 5.

### Embodiment 7

FIG. 25 shows an embodiment 7 of the invention.

The embodiment 7 is directed to a modification of the optical sheet 4 in the same manner as the embodiments 5 and 6, and FIG. 25 is a cross-sectional view of the optical sheet 4. Here, the constitutions other than the constitutional features of the invention which are explained in the embodiment 7 are substantially equal to the constitutions for forming the liquid crystal display device which are explained in the embodiments 1 to 4.

As shown in FIG. 25, with respect to the optical sheet 4 of the embodiment 7, a cross-sectional shape of a convex lens including an apex is configured such that an oblique surface of the cross section of the lens is constituted of a curved line, and an angle θ6 made by a tangent of the oblique surface close to the apex of the lens and a bottom surface of the lens is set smaller than an angle θ5 made by a tangent of the oblique surface close to the bottom surface of the lens and the bottom surface of the lens.

By forming the lens into such a shape, it is possible to enhance the peeling property for peeling off the transparent base member from the mold in the same manner as explained in conjunction with the embodiment 5. Further, it is possible to radiate the radiation light from the light radiating surface 11 of the optical sheet 4 by further focusing the radiation light in the direction toward the front surface of the liquid crystal display panel 1 and hence, the brightness in the direction toward the front surface of the liquid crystal display panel 1 can be enhanced.

### Embodiment 8

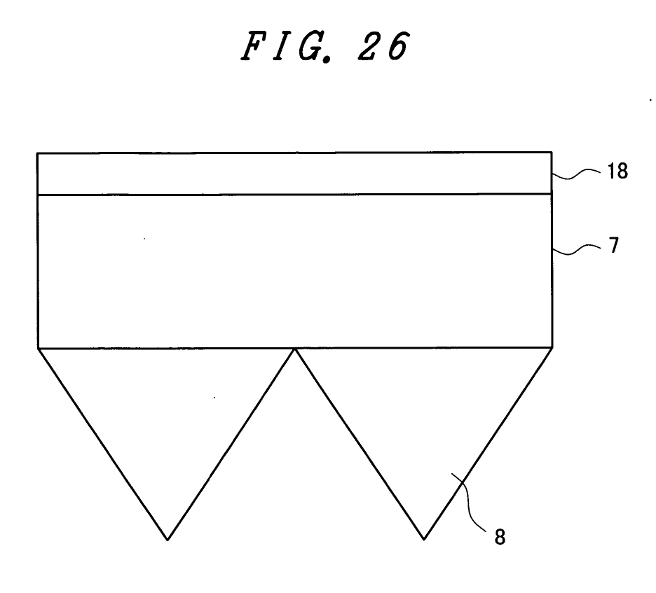

FIG. 26 is a view showing an embodiment 8 of the invention.

The embodiment 8 is directed to a modification of the optical sheet 4 in the same manner as the embodiments 5, 6 and 7, and FIG. 26 is a cross-sectional view of the optical sheet 4. Here, the constitutions other than the constitutional features of the invention which are explained in the embodiment 8 are substantially equal to the constitutions for forming the liquid crystal display device which are explained in the embodiments 1 to 4.

As shown in FIG. 26, with respect to the optical sheet 4 of the embodiment 8, a member having a light diffusion effect is arranged on a surface of a side of a transparent base member 7 opposite to convex lenses. Here, as an example of the member having a light diffusion effect, resin-made beads may be applied to the surface of the transparent basic member 7 by coating together with a binder.

Due to such a constitution, it is possible to control the angular distribution of the radiation light from the radiation surface 11 of the optical sheet 4 and it is also possible to prevent a moire pattern attributed to the interference between the optical sheet and the liquid crystal display panel.

Here, in this specification, the explanation has been made with respect to the case in which the shape of the bottom surfaces of the lenses which constitute the optical sheet is the circle. However, this implies that the circular bottom surface shape is optimum in this specification and the bottom surface shape may be formed in an elliptical shape. Here, when the bottom surface adopts the elliptical shape, the periodic property of the lens is determined based on the focal position of the ellipse. Further, the bottom surface may be formed in a polygonal shape.

What is claimed is:

1. A liquid crystal display device which includes a liquid crystal display panel and a backlight device, wherein
the backlight device is a side-light-type backlight device which includes a light guide plate and spot light sources arranged on one side surface of the light guide plate,
an optical sheet is arranged between the backlight device and the liquid crystal display panel,
the optical sheet is formed of a transparent base member and a plurality of convex lenses which is arranged on a surface on a backlight-device-side of the transparent base member, and
the convex lenses have a circle bottom surface shape, and the centers of the bottom surfaces of the convex lenses are periodically arranged.

2. A liquid crystal display device according to claim 1, wherein a shape which connects the centers of the bottom surfaces of the convex lenses which are arranged close to each other forms a square.

3. A liquid crystal display device according to claim 1, wherein a shape which connects the centers of the bottom surfaces of the convex lenses which are arranged close to each other forms an equilateral triangle.

4. A liquid crystal display device according to claim 1, wherein a shape which connects the centers of the bottom surfaces of the convex lenses which are arranged close to each other forms a rectangular shape.

5. A liquid crystal display device according to claim 1, wherein an interval between the centers of the bottom surfaces of the convex lenses which are arranged close to each other differs between the direction parallel to one side surface of the light guide plate and the direction perpendicular to one side surface of the light guide plate.

6. A liquid crystal display device according to claim 1, wherein the convex lenses are arranged such that portions of the bottom surfaces of the respective convex lenses are overlapped to each other.

7. A liquid crystal display device according to claim 1, wherein the convex lenses are conical lenses, and an apex angle of the conical lenses is set to 50 degrees or more and 100 degrees or less.

8. A liquid crystal display device according to claim 1, wherein the convex lens has a distal end portion thereof formed into a flat surface.

9. A liquid crystal display device according to claim 1, wherein the convex lens sets a height thereof to a value equal to or less than a length of a diameter of the bottom surface of the lens.

10. A liquid crystal display device according to claim 1, wherein the interval between the centers of the bottom surfaces of the convex lenses which are arranged close to each other is set such that the distance between the centers of the bottom surfaces of the convex lenses in the direction parallel to one side surface is smaller than the distance between the centers. of the bottom surfaces of the convex lenses in the direction perpendicular to one side surface.

11. A liquid crystal display device according to claim 1, wherein the spot light sources are formed of a plurality of spot light sources.

12. A liquid crystal display device according to claim 1, wherein an interval between the centers of the bottom surfaces of the convex lenses which are arranged close to each other is set to 5 μm or more and 500 μm or less with respect to both of the lenses which are arranged in the direction parallel to one side surface of the light guide plate and the lenses which are arranged in the direction perpendicular to one side surface of the light guide plate.

13. A liquid crystal display device according to claim 1, wherein the transparent base member arranges a member having a light diffusion effect in the inside thereof or on a surface thereof opposite to the surface on which the convex lenses are arranged.

14. A liquid crystal display device according to claim 13, wherein the member having a light diffusion effect is a light diffusion film.

15. A liquid crystal display device according to claim 1, wherein a cross-sectional shape of the convex lens including an apex thereof is configured such that an oblique surface of the lens is formed of at least two straight lines, and an angle made by the oblique surface on a side close to the apex of the lens and the bottom surface of the lens is set smaller than an angle made by the oblique surface on a side close to the bottom surface of the lens and the bottom surface of the lens.

16. A liquid crystal display device according to claim 1, wherein a cross-sectional shape of the convex lens including an apex thereof is configured such that an oblique surface of the cross section of the lens is formed of a curved line and an angle made by a tangent of the oblique surface on a side close to the apex of the lens and the bottom surface of the lens is set smaller than an angle made by a tangent of the oblique surface on a side close to the bottom surface of the lens and the bottom surface of the lens.

17. A liquid crystal display device which includes a liquid crystal display panel and a backlight device, wherein
the backlight device is a side-light-type backlight device which includes a light guide plate and a light source arranged on one side surface of the light guide plate,
an optical sheet is arranged between the backlight device and the liquid crystal display panel,
the optical sheet is formed of a sheet-like transparent base member and a plurality of convex lenses which are arranged on a surface on a backlight-device-side of the transparent base member, and
the convex lenses have a circle bottom surface shape, and the centers of the bottom surfaces of the convex lenses are periodically arranged.

18. A liquid crystal display device according to claim 17, wherein with respect to an interval between the centers of the bottom surfaces of the convex lenses which are arranged close to each other, the interval between the centers of the bottom surfaces of the convex lenses in the direction parallel to one side surface is set smaller than the interval between the centers of the bottom surfaces of the convex lenses in the direction perpendicular to one side surface.

19. A liquid crystal display device according to claim 17, wherein the convex lenses are arranged such that portions of the bottom surfaces of the respective convex lenses are overlapped to each other.

20. A liquid crystal display device according to claim 17, wherein the convex lenses are conical lenses, and an apex angle of the conical lenses is set to 50 degrees or more and 100 degrees or less.

21. A liquid crystal display device according to claim 17, wherein the convex lens sets a height thereof to a value equal to or less than a length of a diameter of the bottom surface of the lens.
